(19) United States
(12) Patent Application Publication
(10) Pub. No.: US 2003/0208772 A1
(43) Pub. Date: Nov. 6, 2003

(54) Digital subscriber line head-end

(75) Inventor: Celite Milbrandt, Austin, TX (US)

Correspondence Address: Gary W. Hamilton, HAMILTON & TERRILE, LLP, PO Box 203518, Austin, TX, 78720, US

(73) Assignee: Celite Systems, Austin, TX

(21) Appl. No.: 10/137,624

(22) Filed: May 2, 2002

(51) Int. Cl. H04N 7/173

(52) U.S. Cl. 725/114; 725/91

(57) ABSTRACT

Digital subscriber line (DSL) head-end. The invention uses downstream broadcast from DSL Head End to subscribers and slicing of upstream data from the subscribers to the DSL Head End or point-to-point upstream. Multiple lines are driven simultaneously thereby significantly lowering central office hardware costs. A peripheral, DSL Head End is added to a cross-connect box, or a next generation digital loop carrier (NG-DLC), to facilitate broadband Internet and video service capabilities. A DSL Head End may be added to each cross-connect box, or to each distribution area to provide an efficient cost-effective solution for provisioning DSL service.

### BACKGROUND

1. Technical Field

The invention relates generally to communication systems employing digital subscriber line systems. More specifically, it relates to protocols employed by a communication system employing a digital subscriber line head-end that broadcasts to any number of subscribers in a communication network.

2. Background

Current approaches for providing broadband Internet access using digital subscriber line (DSL) services are complex and expensive to deploy. In the residential context, there is the difficulty in spanning that last segment of infrastructure to a user's site. This is the segment of the network, often referred to as “the last mile,” which presents the most significant bottleneck in terms of ensuring broadband services to a user. While there has been discussion of providing broadband (e.g. fiber-optic) cabling up to every user site, there are virtually no examples of this cabling solution that have been implemented.

Even if a service provider uses a “brute force” cabling solution to provide broadband access to a facility, it is often necessary to extend the broadband access to multiple users within the facility. Many business users provide multiple user access with a local area network within the facility. There is a need, therefore, for a cost-effective solution for providing broadband service over the “last mile” to multiple users.

### SUMMARY OF THE INVENTION

The present invention provides DSL service using downstream broadcast from a DSL Head End to subscribers and optional slicing of upstream data from the subscribers to the DSL Head End. Multiple lines are driven simultaneously thereby significantly lowering central office hardware costs. The optional slicing of the upstream data, may be performed in a variety of ways. For example, the slicing may be performed using time-division multiple access (TDMA), code division multiple access (CDMA) or other techniques understood by those skilled in the art. Alternatively, upstream transmission of data can be accomplished using point-to-point links. The DSL Head End can be added to a cross-connect box or a next generation digital loop carrier (NG-DLC). In this implementation, DSL data is transmitted over an F1/main feed to a cross-connect box. The DSL Head End is operably connected via tap connections to the F1 feed or to F2 feeds within the cross connect box. The DSL Head End may be added to each cross-connect box, or to each distribution area.

### BRIEF DESCRIPTION OF THE DRAWINGS

A better understanding of the invention can be obtained when the following detailed description of various exemplary embodiments is considered in conjunction with the following drawings.

FIG. 1 is a system diagram illustrating an embodiment of a prior art distribution area.

FIG. 2a is a system diagram illustrating a prior art embodiment of a DSL system for downstream and upstream broadcasting for a plurality of users.

FIG. 2b is a system diagram illustrating an embodiment of communication within a digital subscriber line (DSL) head-end system employing point-to-multipoint downstream broadcast and point-to-point upstream broadcast.

FIG. 2c is a system diagram illustrating an embodiment of communication within a digital subscriber line (DSL) head-end system employing point-to-multipoint downstream broadcast and frequency or time-division multiplexing broadcast upstream.

FIG. 2d is a system diagram illustrating an embodiment of communication within a digital subscriber line (DSL) head-end system employing point-to-multipoint downstream broadcast and frequency or time-division multiplexing broadcast upstream with a 2:1 ratio.

FIG. 3 is a system diagram illustrating an embodiment of a DSL distribution system showing the DSL Head End of the present invention connected at various locations within the system.

FIG. 3A is a block diagram illustration of the system components of the DSL Head End of the present invention.

FIG. 4 is a system diagram illustrating an embodiment of a modified cross-connect box having a DSL Head End connected thereto.

FIG. 5 is a system diagram illustrating an embodiment of DSL Head End interconnections within the cross-connect box.

FIG. 6 is a system diagram illustrating an embodiment of digital subscriber line (DSL) downstream channel broadcast that is performed in accordance with the present invention.

FIG. 7 is a system diagram illustrating an embodiment of digital subscriber line (DSL) upstream channel slicing that is performed in accordance with the present invention.

FIG. 8 is a functional block diagram illustrating an embodiment of a digital subscriber line (DSL) head-end communication method that is performed in accordance with the present invention.

FIG. 9A is a functional block diagram illustrating an embodiment of a digital subscriber line (DSL) head-end downstream communication method that is performed in accordance with the present invention.

FIG. 9B is a functional block diagram illustrating an embodiment of a digital subscriber line (DSL) head-end upstream communication method that is performed in accordance with the present invention.

### DETAILED DESCRIPTION OF THE INVENTION

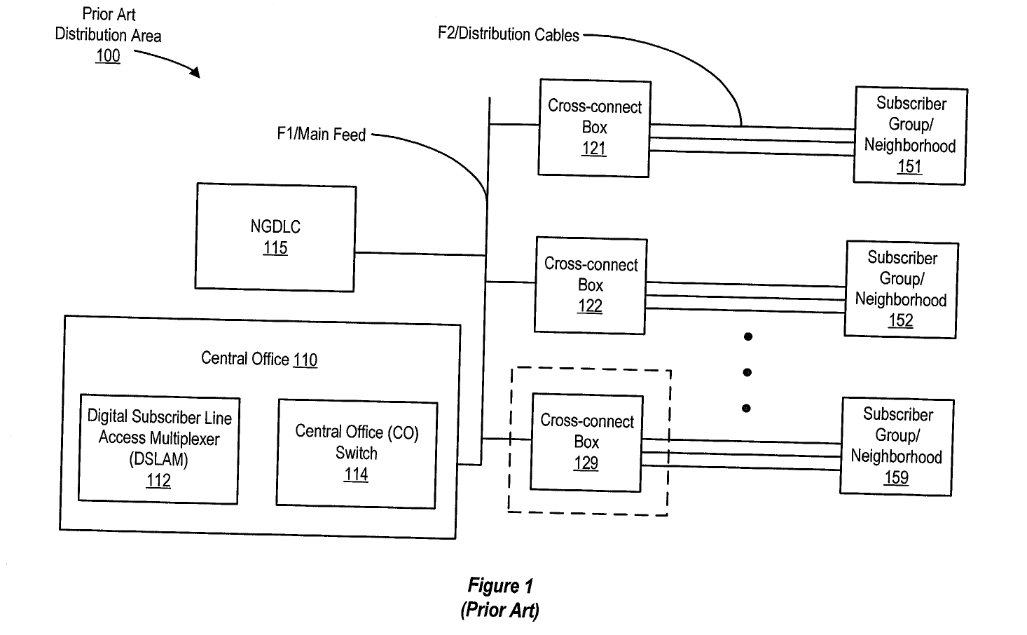

FIG. 1 is a system diagram illustrating an embodiment of a prior art distribution area 100. A central office 110 provides an F1/main feed distribution that may be employed to service different subscriber groups as well. In the illustration of the FIG. 1, the F1/main feed provides connectivity to a number of cross-connect boxes 121, 122, . . . and 129. Each of the cross-connect boxes 121, 122, . . . , and 129 provide servicing via F2/distribution cables to subscriber groups/neighborhoods 151, 152, . . . , and 159, respectively. One or more of the cross-connect boxes 121, 122, . . . and 129 may employ a next generation digital loop carrier (NG-DLC) 115.

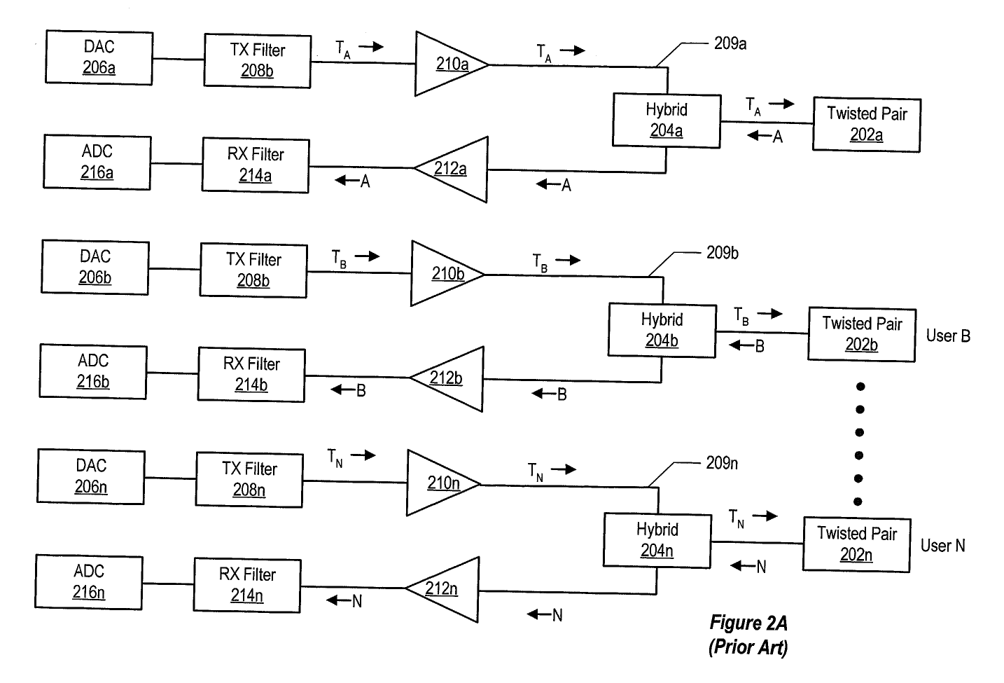

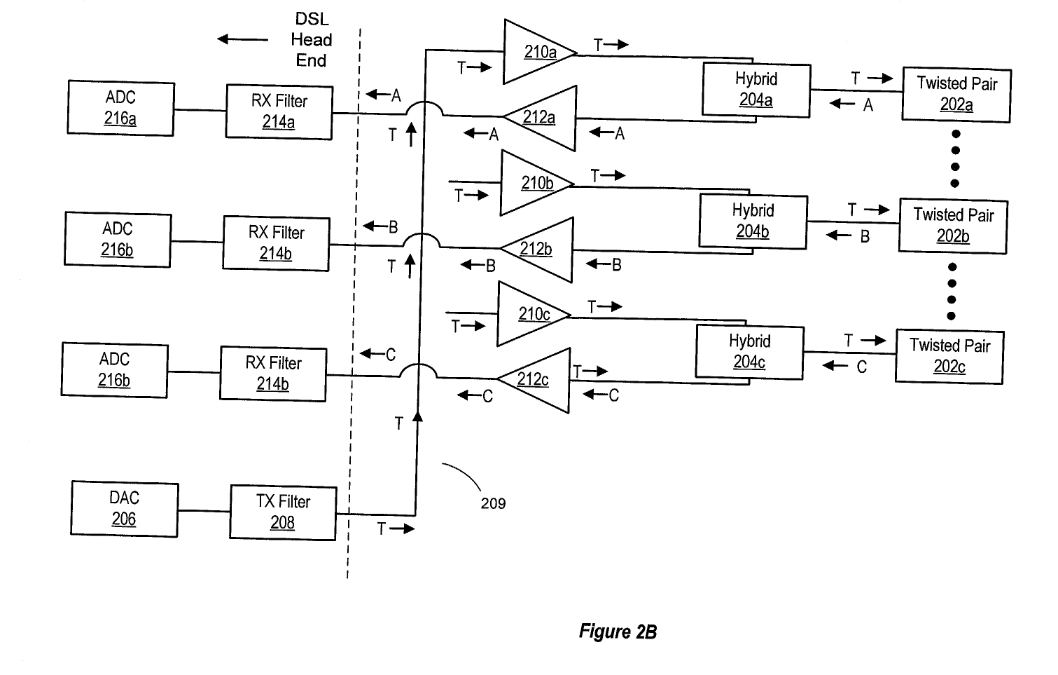

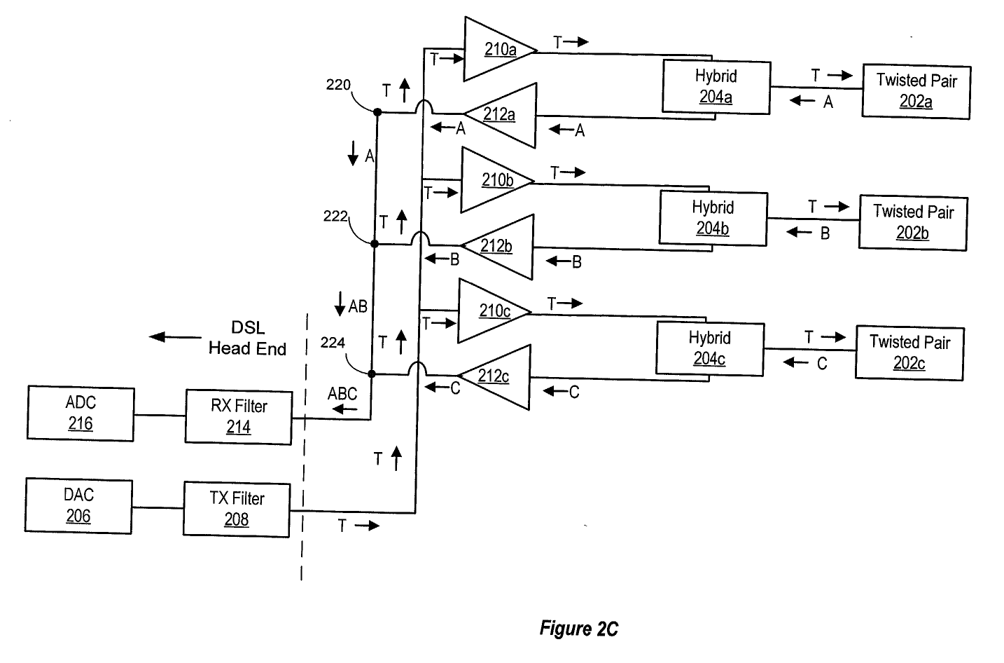

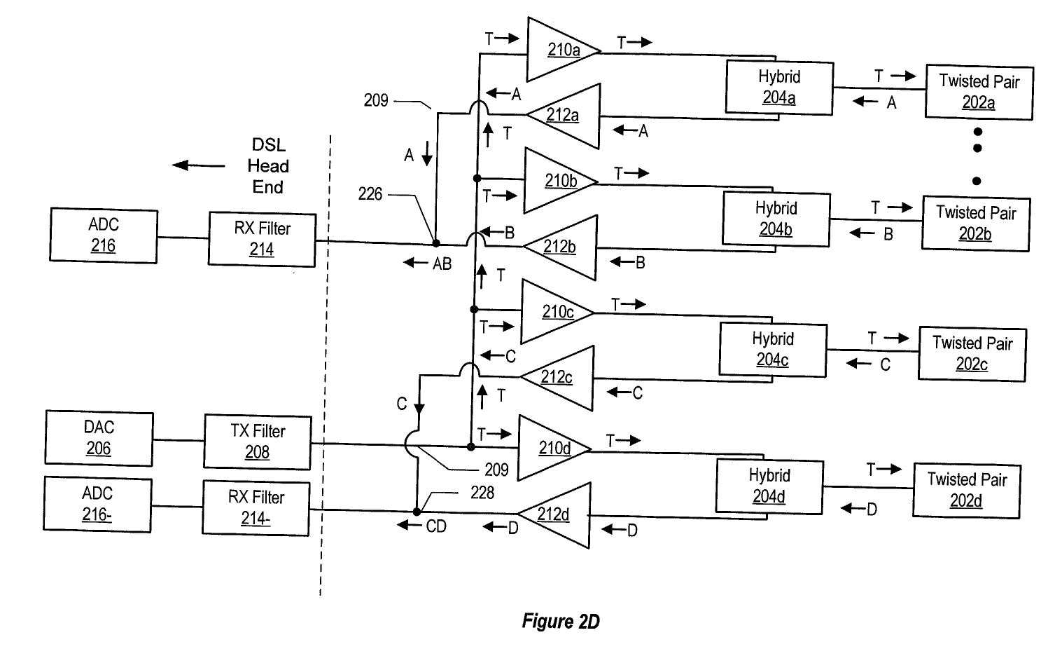

FIG. 2a is an illustration of a prior art architecture for providing DSL service from a cross-connect box to a plurality of end Users A, B, . . . N. Downstream transmission for Users A, B, . . . N is illustrated by arrows T_{A}, T_{B} and T_{N}, respectively. Upstream transmission for users A. B, . . . N is illustrated by arrows “A,” “B” and “N” respectively. Referring to the illustration for User A, the twisted pair 202a at the user site is connected to a hybrid connector 204a that provides interconnection of shielded copper twisted pair wires with other transmission media within the DSL distribution network. Data transmitted downstream is received by the digital-to-analog converter 206a and is then passed through the transmitter filter 208a and though the line driver 210a to the hybrid connector 204a and finally to the User A twisted pair 202a. Data transmitted upstream passes from the User A twisted pair 202a through the hybrid circuit 204a to the receiver function 212a. The data is then transmitted to the receiver filter 214a and the analog-to-digital converter 216a to the DSL network. In the prior art architecture illustrated in FIG. 2A, it is necessary to provide duplicate system components for each of the end users. The various architectures of the present invention, discussed in greater detail below, allow a significant reduction in the number of components needed to provide DSL service to a plurality of users.

FIG. 2b illustrates an architecture for delivering DSL service using point-to-multipoint downstream broadcast and point-to-point upstream unicast. Data transmitted downstream is received by the digital-to-analog converter 206 and is then passed through the transmitter filter 208. The downstream transmitted data is carried on transmission line 209 and distributed to each of the Users A, B, and C along the transmission path illustrated by the arrows labeled “T.” For example, downstream data for User A travels through line driver 210a and hybrid connector circuit 204a and is received on twisted pair 202a at the User A site. The downstream broadcast is also transmitted through corresponding system components and received by User B and User C. Upstream transmission from User A is illustrated by the transmission arrow “A” in FIG. 2B. Data from the twisted pair 202a is passed through the hybrid connector 204a and receiver function 212a. This data is processed by receiver filter 214a and is then converted in analog-to-digital converter 216a for transmission upstream. Upstream transmissions from User B and User C are illustrated by arrows “B” and “C,” respectively, with the upstream data passing through the system components corresponding to those discussed above with respect to upstream transmission for User A.

FIG. 2C illustrates an architecture for delivering DSL service using point-to-multipoint downstream broadcast and frequency and/or time-division multiplexing. Data transmitted downstream is received by the digital-to-analog converter 206 and is then passed through the transmitter filter 208. The downstream transmitted data is carried on transmission line 209 and distributed to each of the Users A, B, and C along the transmission path illustrated by the arrows labeled “T.” For example, downstream data for User A travels through line driver 210a and hybrid connector circuit 204a and is received on twisted pair 202a at the User A site. The downstream broadcast is also transmitted through corresponding system components and received by User B and User C. Upstream transmission from User A is illustrated by the transmission arrow “A” in FIG. 2C. Data from the twisted pair 202a is passed through the hybrid connector 204a and receiver function 212a. Upstream transmissions from User B and User C are illustrated by arrows “B” and “C,” respectively, with the upstream data passing through the system components corresponding to those discussed above with respect to upstream transmission for User A. Referring to the dataflow in FIG. 2C, upstream data from User A passes through node 220 and proceeds to node 222 where it is combined by an appropriate slicing technique with upstream data from User B, as illustrated by the transmission arrow “AB.” The “AB” data stream proceeds to node 224 where it is combined with the upstream data from User C as illustrated by the transmission arrow “ABC.” The data slicing techniques employed to combine the upstream data include time-division multiplexing or frequency division multiplexing as will be understood by those skilled in the art. The combined data “ABC” is processed by receiver filter 214 and is then converted in analog-to-digital converter 216 for transmission upstream.

FIG. 2D illustrates an architecture for delivering DSL service using point-to-multipoint downstream broadcast and frequency-division or time-division multiplexing broadcast upstream with a 2:1 ratio. Data transmitted downstream is received by the digital-to-analog converter 206 and is then passed through the transmitter filter 208. The downstream transmitted data is carried on transmission line 209 and distributed to each of the Users A, B, C and D along the transmission path illustrated by the arrows labeled “T.” For example, downstream data for User A travels through line driver 210a and hybrid connector circuit 204a and is received on twisted pair 202a at the User A site. The downstream broadcast is also transmitted through corresponding system components and received by User B, User C and User D. Upstream transmission from User A is illustrated by the transmission arrow “A” in FIG. 2D. Data from the twisted pair 202a is passed through the hybrid connector 204a and receiver function 212a. Upstream transmissions from User B, User C and User D are illustrated by arrows “B,” “C” and “D,” respectively, with the upstream data passing through the system components corresponding to those discussed above with respect to upstream transmission for User A. Referring to the upstream dataflow in FIG. 2D, upstream data from User A is transmitted to node 226 where it is combined by an appropriate slicing technique with upstream data from User B as illustrated by the transmission arrow “AB.” The “AB” data stream is then processed by the receiver filter 214 and is then converted in analog-to-digital converter 216 for transmission upstream. Data from User C is transmitted to node 228 where it is combined with the upstream data from User D as illustrated by the transmission arrow “CD.” The “CD” data stream is processed by the receiver filter 214 and is then converted in analog-to-digital converter 216 for transmission upstream. As discussed above, the data slicing techniques employed to combine the upstream data include time-division multiplexing and/or frequency division multiplexing as will be understood by those skilled in the art.

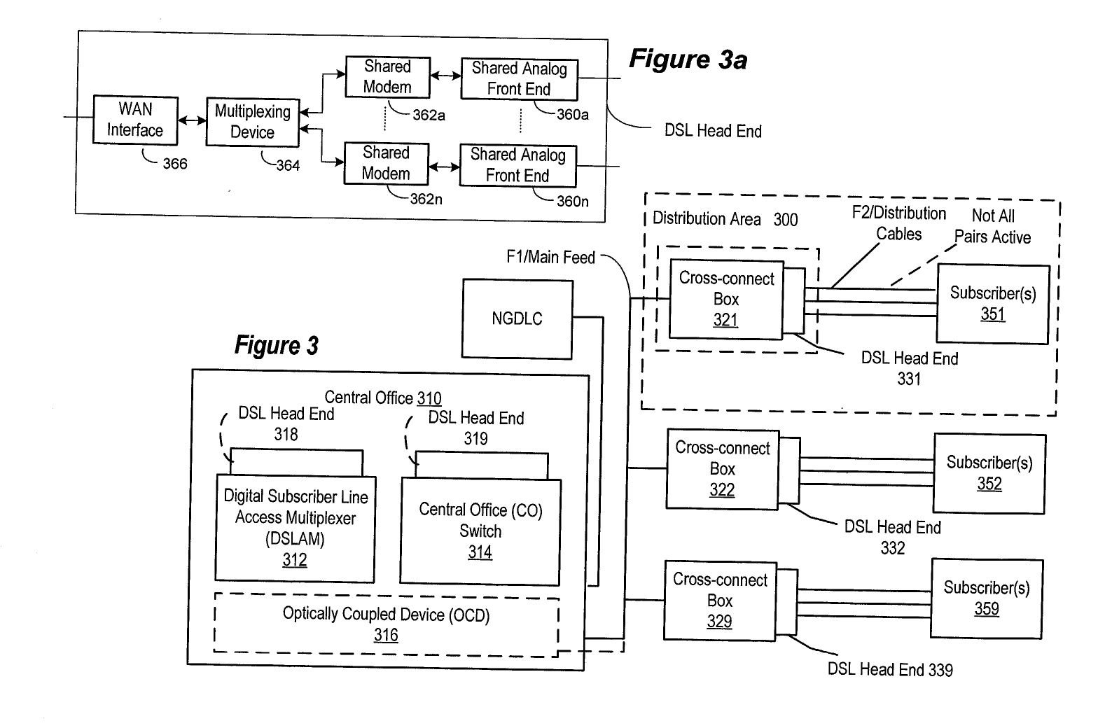

FIG. 3 is a system diagram illustrating an embodiment of a distribution area 300 that is configured in accordance with one embodiment of the present invention. A central office 310 provides an F1/main feed cable to distribution points within the distribution area 300. The distribution points typically include cross-connect boxes, shown as cross-connect box 321, cross-connect box 322, . . . , and cross-connect box 329. The cross-connect boxes connect the F1 main feed cables to F2 distribution cables that provide service to a large number of subscribers, shown as subscriber(s) 351, subscriber(s) 352, . . . , and subscriber(s) 359.

In one embodiment shown in FIG. 3, a DSL Head End is attached to each of the cross-connect boxes 321-329. For example, a DSL Head End 331 is attached to the cross-connect box 321. The DSL Head End 331 is operable to bring the broadband service capabilities to the last section of access to the subscriber(s) 351-359. As will be described in greater detail below, the interconnections within each of the DSL Head Ends may be performed by “tapping off” each active F2 pair within the cross-connect loop. In some embodiments, F2/distribution cable pairs are communicatively coupled to each subscriber even though only a fraction of the connection is actually used at the time the head-end is installed. Since the F2 pairs are already connected, subsequent users can be provided with DSL service remotely, without the need for service personnel to physically travel to the cross-connect box to establish a new connection.

By using the configuration illustrated in FIG. 3, broadband service capabilities may be offered to the subscriber(s) 351-359 without a radical overhaul of the systems' communication hardware or significant man-hours to enable those services. The last section of communication hardware, that is often provisioned via copper cabling, may still be used at its highest data rate capabilities thanks to the functionality of the DSL Head End.

Within the central office 310, a digital subscriber line access multiplexer (DSLAM) 312 and a central office switch 314 operate cooperatively to ensure that each of the subscriber(s) 351-359 can access the broadband capabilities of DSL. When the broadband hardware transmission out to the cross-connect boxes 321-329 is provisioned using fiber-optic cabling, an optically coupled device (OCD) 316 is integrated within the central office 310 to ensure the proper optical to electric/optical to electrical signal conversion of the signaling coming into and out of the OCD 316. Optically provisioned cabling from the central office 310 to the cross-connect boxes 321-329 can be used to enable video service capabilities for the subscriber(s) 351-359.

The DSL Head End has the advantage of being added to the legacy hardware implementation as a peripheral box operably connected to an existing cross-connect box. Moreover, the present invention diverges from many other proposed solution, in that, the present invention avoids large-scale hardware upgrades that are typically in DSL prior art interpretations necessary.

The DSL Head End may be connected at other locations within the distribution area 300 without departing from the scope and spirit of the invention. For example, the DSL Head End may be added within the central office 310 itself. The embodiment discussed above wherein the DSL Head End is located at the cross-connect boxes 321-329 is an example of a nearly non-invasive solution that provides broadband service capabilities to the subscriber(s) 351-359. In embodiments where one or more of the cross-connect boxes is implemented using next generation digital loop carrier (NG-DLC) technologies, the DSL Head End may be placed within the NG-DLC.

FIG. 3A illustrates the major system components of the DSL Head End used in the various embodiments described herein. The upstream and down stream data flow is processed by a shared analog front-end 360a-360n (for up to N users) and by a shared modem 362a-362n. An appropriate multiplexing device 364 implements the various upstream slicing techniques discussed herein and a WAN interface handles processing of data flow between the DSL Head End and a wide-area network.

When a subscriber connects customer premises equipment, such as a modem, the customer premises equipment sends upstream channel information to the DSL Head End. The customer premises equipment requests bandwidth from a bandwidth controller through appropriate messaging protocol. The DSL Head End grants upstream channel bandwidth based on TDMA, CDMA or other slicing techniques. Alternatively, the upstream transmission can be based on point-to-point protocol. In this embodiment, the customer premises equipment transmits a “training” signal and the DSL Head End synchronizes and equalizes the signal for upstream transmission. The customer premises equipment can send and receive data to and from an Internet router, a DSLAM, an ATM switch, a phone switch or any other device that is connected directly or indirectly to the WAN interface port.

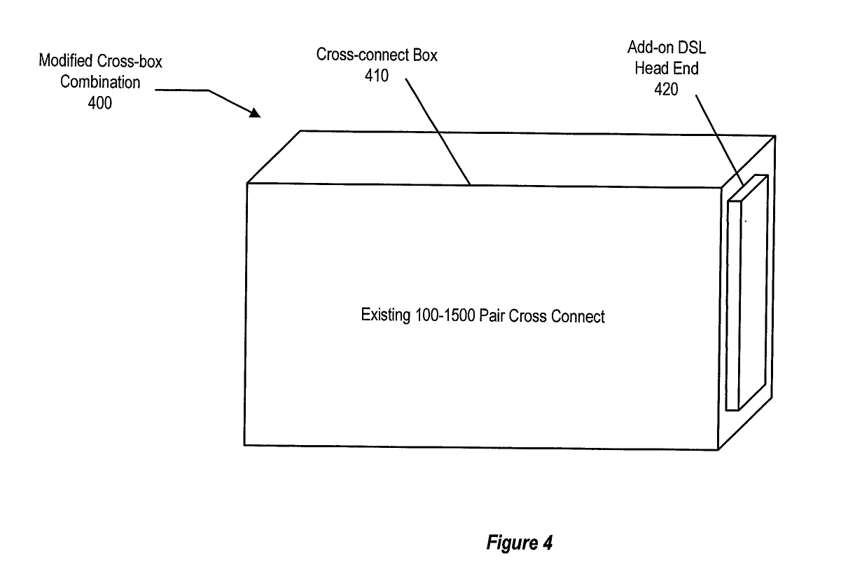

FIG. 4 is a system diagram illustrating an embodiment of a modified cross-connect box 400 that is built in accordance with certain aspects of the present invention. In one configuration, the cross-connect box 410 includes an existing 900 pair cross-connect. However, the number of pairs may vary between 100 and 1500 pairs in current cross connect boxes. An add-on DSL Head End 420 has been communicatively coupled to the cross-connect box 410 to enable broadband service capabilities to the subscribers that are serviced by the cross-connect box 410. The DSL Head End 420 does not significantly alter the physical size of the cross-connect box 410, and it may be added without requiring the cross-connect box 410 itself to be removed from its installation site. The present invention provides a solution to ensure broadband service capabilities to the subscribers with relative ease compared to prior art solutions for extending broadband service across the last section of communication system to the subscribers.

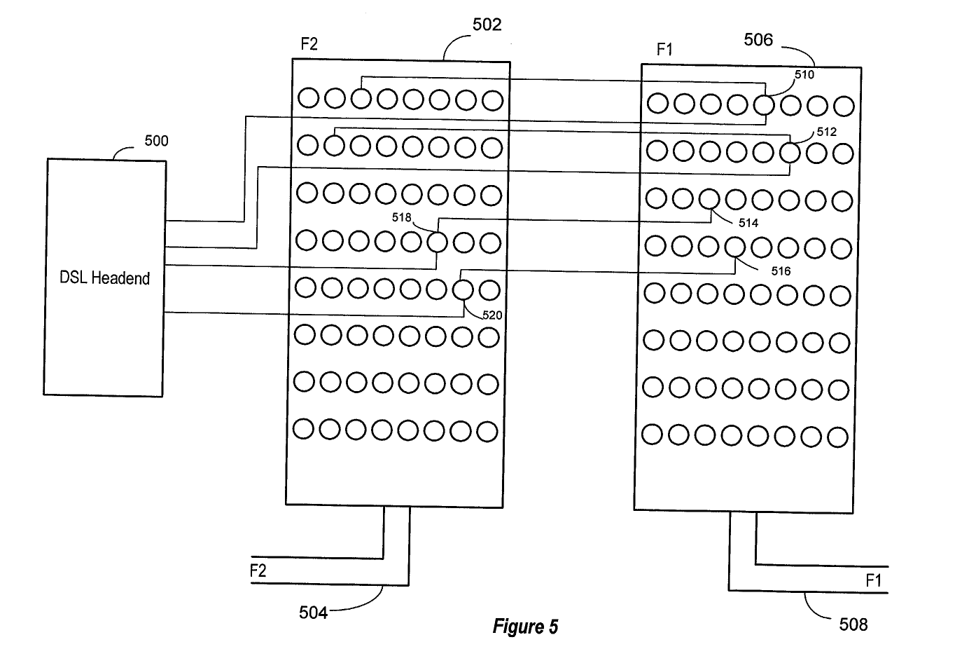

FIG. 5 is a system diagram illustrating an embodiment of interconnections between the F1 and F2 cables and the DSL Head End 500. In one embodiment, the F1 cables can be connected directly to the DSL Head End 500 as illustrated by the connection of terminals 510 and 512 directly to the Head End. Alternatively, the various F1 cables can be connected to the F2 cables, which are further connected to the DSL Head End 500. For example, the F1 cable terminals 514 and 516 are shown connected to F2 cable terminals 518 and 520, which are further connected to the DSL Head End 500. As was discussed above each of the F1 cables can be connected to respective F2 terminals even though the customer provide equipment corresponding to a particular F2 terminal may not be activated at the time the connection is initially established. Various users can be subsequently provided with DSL service by remotely activating the F2 connections without the need to have a technician physically return to the cross-connect box, thereby reducing the cost of provisioning DSL service.

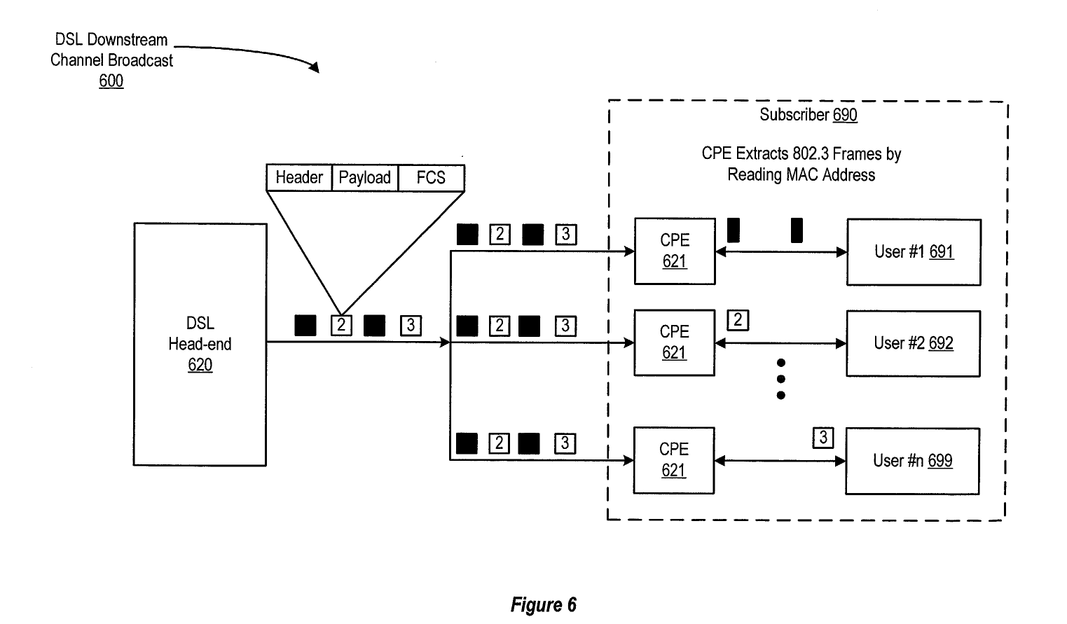

FIG. 6 is a system diagram illustrating an embodiment of digital subscriber line (DSL) downstream channel broadcast 600 from a DSL Head End 620 using a broadcast format to subscribers 690. The broadcast includes data that are to be used by multiple of the subscribers 690 (shown as a User #1 691, a User #2 692, . . . , and a User #n 699). In this embodiment, an IEEE compatible 802.3 frame (e.g., an Ethernet compatible frame) is shown as having a header, a payload and frame control sequence (FCS) information. Each of the users has dedicated customer premises equipment (CPE), shown as CPE 621, CPE 622, . . . , and CPE 629. The CPEs 621-629 are operable to extract the data (by using the media access control address) that are appropriate for their respective user. Those data are then forwarded onto the user and the non-relevant data may be discarded as they are not needed for that particular user.

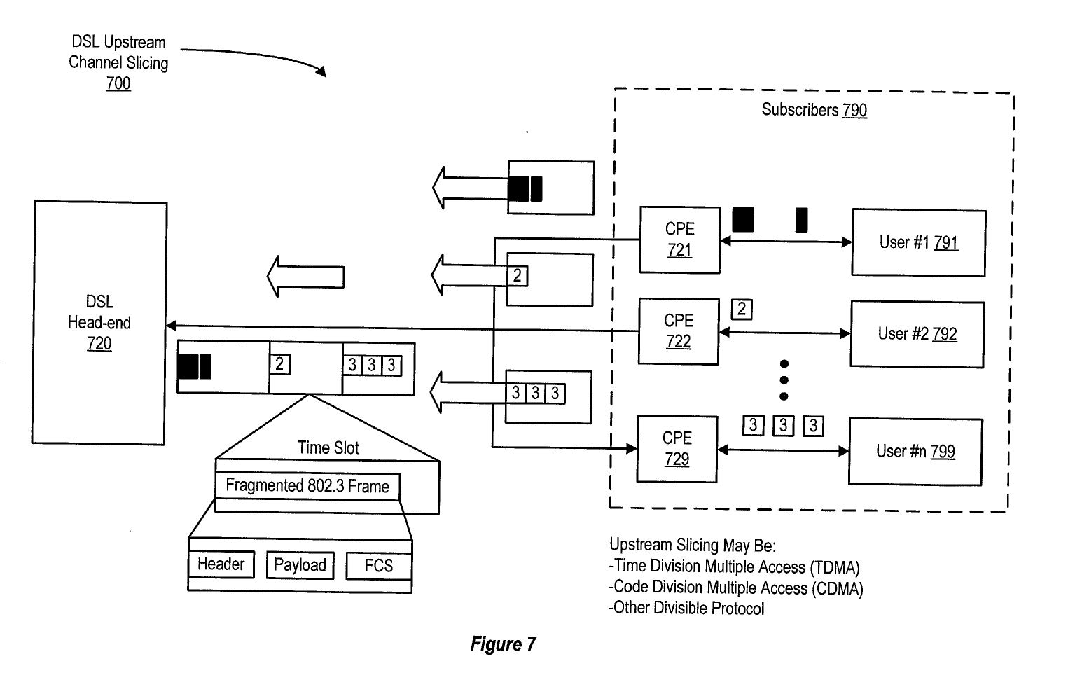

FIG. 7 is a system diagram illustrating an embodiment of digital subscriber line (DSL) upstream channel slicing 700. This embodiment shows subscribers 790 (shown as a User #1 791, a User #2 792, . . . , and a User #n 799) transmitting data upstream to a DSL Head End 720 via dedicated customer premises equipment (CPE), shown as CPE 721, CPE 722, . . . , and CPE 729. The CPE 721-729 operate cooperatively to assemble a data frame. In this embodiment, a fragmented 802.3 frame is assembled within a time slot. The fragmented 802.3 frame is shown as having a header, a payload and frame control sequence (FCS) information.

The DSL Head End 720 can be configured to perform slicing of the fragmented 802.3 frame for appropriate handling of each of the data received from the various users. Again, the upstream slicing may be implemented using time-division multiple access (TDMA), code division multiple access (CDMA), or any slicing method that is operable to decipher the data/code as it is transmitted upstream to the DSL Head End 720. Alternatively, as discussed above, upstream data transmission can be accomplished using point-to-point transmission methods.

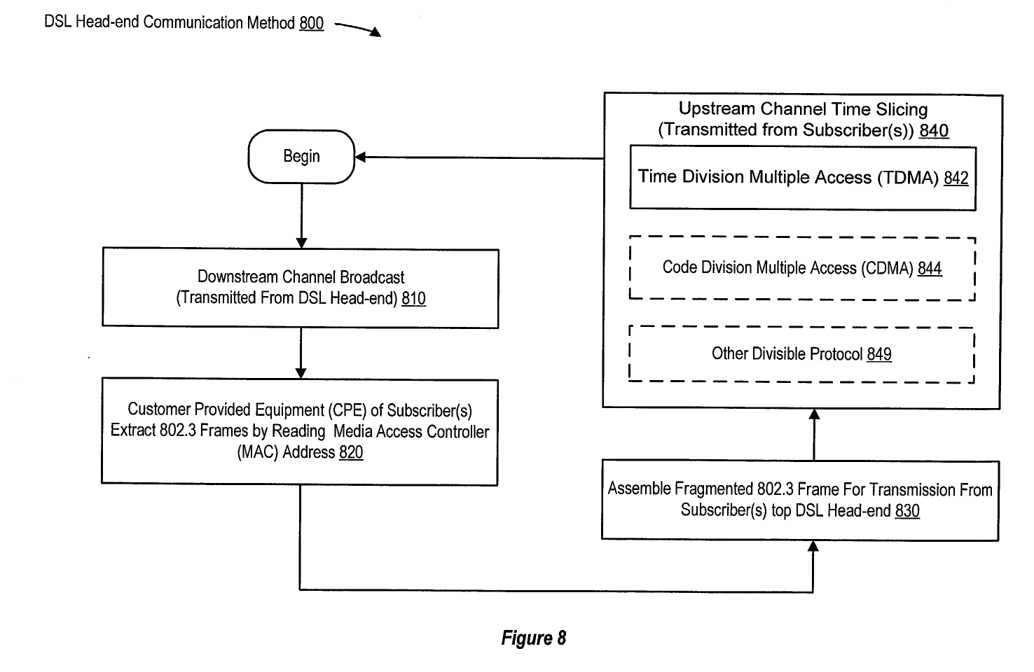

FIG. 8 is a functional block diagram illustrating an embodiment of a digital subscriber line (DSL) head-end communication method 800 that is performed in accordance with certain aspects of the present invention. The communication may be viewed as being a continual loop of downstream broadcast and upstream slicing. Beginning at block 810, data is transmitted via the downstream channel in a broadcast manner; i.e., the DSL Head End transmits the same data downstream to all subscribers. In a block 820, customer premises equipment (CPE) of each of the subscriber(s) extracts the 802.3 or DOCSIS or other frames by reading the media access controller (MAC) address.

In block 830, a fragmented 802.3 frame is assembled for upstream transmission from the subscriber(s) to the DSL Head End. This assembly is performed by receiving and assembling the data portions from each of the subscriber(s) to generate the fragmented 802.3 frame for transmission upstream. In a block 840, the assembled frame, that has been transmitted upstream from the subscriber(s), is sliced for appropriate handling by the DSL Head End. Again, the upstream slicing as performed in the block 840 may be performed using time-division multiple access (TDMA) 842. Alternatively, it may be performed using code division multiple access (CDMA) 844, or any other divisible protocol 849 that is operable to decipher the data/code as it is transmitted upstream. Also, as discussed previously, upstream transmission can be implemented using point-to-point techniques.

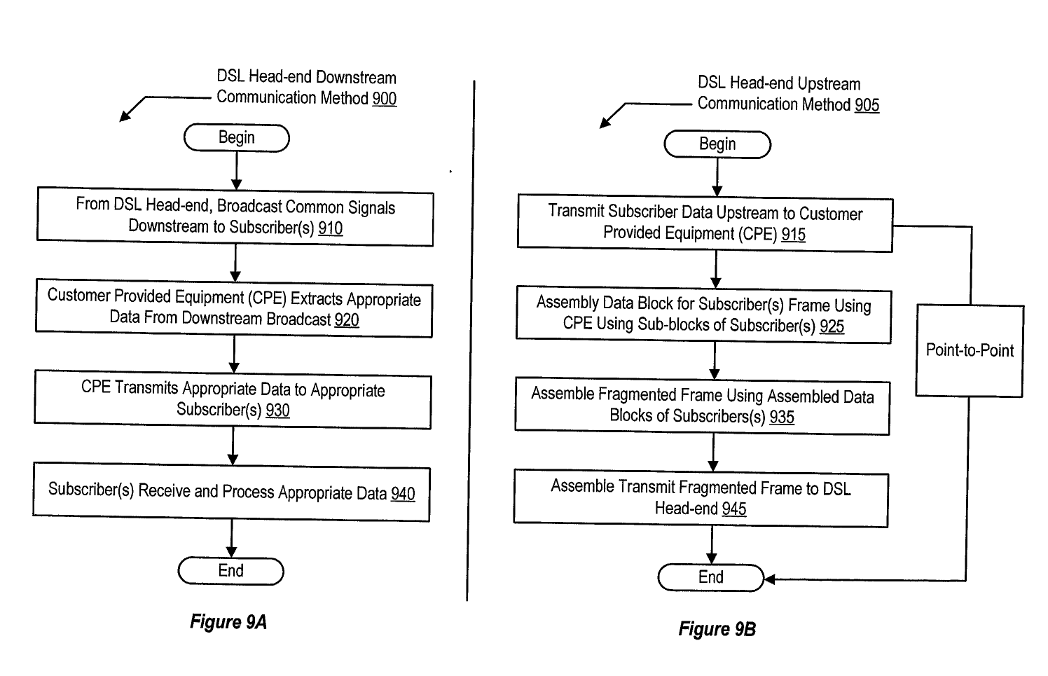

FIG. 9A is a functional block diagram illustrating an embodiment of a digital subscriber line (DSL) head-end downstream communication method 900. In a block 910, common data signals are broadcast downstream from a DSL Head End to subscriber(s). In a block 920, customer premises equipment (CPE), dedicated for individual groups/neighborhoods of subscriber(s), extract the appropriate data for those subscriber(s). In a block 930, the CPE forwards that data to appropriate subscriber(s). Finally, in a block 940, the appropriate subscriber(s) receive and process the data.

FIG. 9B is a functional block diagram illustrating an embodiment of a digital subscriber line (DSL) head-end upstream communication method 905. In a block 915, an individual subscriber transmits data upstream to customer premises equipment (CPE). In a block 925, within the CPE, the data blocks (that may be referred to as sub-blocks of a frame) for each of the subscriber(s) are assembled into a data block for continued upstream transmission to the DSL Head End. In a block 935, a fragmented frame is assembled using the data blocks for the subscriber(s) provided by the appropriate CPE(s). Finally, in a block 945, the now assembled, fragmented frame is transmitted to the DSL Head End. In an alternative embodiment, the communication method discussed above can be accomplished using point-to-point data transmission.

In view of the above detailed description of the invention and associated drawings, other modifications and variations will now become apparent to those skilled in the art. It should also be apparent that such other modifications and variations may be effected without departing from the spirit and scope of the invention.

What is claimed is:

1. A digital subscriber line system, comprising:
a digital subscriber line head-end that is operable to broadcast data downstream to at least one user; and
at least one customer premises equipment communicatively coupled to said digital subscriber line head-end,
wherein said customer premises equipment is operable to extract a payload data portion of the broadcast data and to forward said extracted payload data portion to a user and further operable to assemble a frame from data provided by said user and to transmit said frame upstream to said digital subscriber line head-end; and
said digital subscriber line head-end is operable to perform slicing of said frame that is transmitted upstream.

2. The digital subscriber line communication system of claim 1, wherein the slicing of the frame that is transmitted upstream comprises time-division multiple access processing.

3. The digital subscriber line communication system of claim 1, wherein the slicing of the frame that is transmitted upstream comprises code division multiple access processing.

4. The digital subscriber line communication system of claim 1, wherein the data that are broadcast downstream comprise an IEEE compatible 802.3 frame

5. The digital subscriber line communication system of claim 1, wherein the frame that is transmitted upstream from the user comprises a fragmented IEEE compatible 802.3 frame.

6. A digital subscriber line system, comprising:
a digital subscriber line head-end that is operable to broadcast data downstream to a plurality of users; and
a plurality of customer premises equipment units communicatively coupled to said digital subscriber line head-end, each of said customer premises equipment units being operable to extract a payload portion of the data broadcast downstream and to forward said extracted payload portion of said data to a user, each of said customer—provided equipment further being operable to collect data from a user and to transmit said user data upstream to a receiver using point-to-point protocol.

7. A distribution apparatus for a digital subscriber line, comprising:
a digital subscriber line head-end;
a cross-connect box that is communicatively coupled to a central office via a first set of communication cables and communicatively connected to said digital subscriber line head-end via a second set of communication cables; and
at least one customer premises equipment unit communicatively connected to said digital subscriber line head-end, said customer premises equipment being provided broadband data services upon detection by said digital subscriber line head-end.

8. The distribution apparatus according to claim 7, said first set of cables comprising F1 distribution cables communicatively connected to a central office, said second set of cables comprising F2 distribution cables communicatively connected to said digital subscriber line head-end.

9. A distribution apparatus for a digital subscriber line, comprising:
a cross-connect box that is communicatively coupled to a central office via a first set of F1 communication cables;
a digital subscriber line head-end communicatively coupled to said F1 distribution lines in said cross-connect box; and
at least one customer premises equipment unit communicatively connected to said digital subscriber line head-end, said customer premises equipment being provided broadband data services upon detection by said digital subscriber line head-end.

10. The distribution apparatus for a digital subscriber line of claim 9, wherein
said digital subscriber line head-end is operable to broadcast data downstream to at least one user; and
said customer premises equipment communicatively is coupled to said digital subscriber line head-end, and said customer premises equipment is operable to extract a payload data portion of the data that are broadcast downstream and to forward said extracted payload data portion to the user and further operable to assemble a frame from data provided by said user and to transmit said frame upstream to said digital subscriber line head-end; and
said digital subscriber line head-end is operable to perform slicing of said frame that is transmitted upstream.

11. The distribution apparatus for a digital subscriber line of claim 10, wherein the slicing of the frame that is transmitted upstream comprises time-division multiple access processing.

12. The distribution apparatus for a digital subscriber line of claim 10, wherein the slicing of the frame that is transmitted upstream comprises code division multiple access processing.

13. A distribution apparatus for a digital subscriber line, comprising:
a cross-connect box that is communicatively coupled to a central office via a first set of F1 communication cables;
a digital subscriber line head-end that is operable to broadcast data downstream to a plurality of users; and
a plurality of customer premises equipment units communicatively coupled to said digital subscriber line head-end, each of said customer premises equipment units being operable to extract a payload portion of the data broadcast downstream and to forward said extracted payload portion of said data to a user, each of said customer—provided equipment further being operable to collect data from a user and to transmit said user data upstream to a receiver using point-to-point protocol.

14. A digital subscriber line communication method, comprising:
broadcasting data downstream from a digital subscriber line head-end;
extracting a payload portion of said broadcast data;
forwarding the payload portion of said data to at least one user within a plurality of users;
assembling a frame from data provided by at least one user;
transmitting said frame upstream to the digital subscriber line head-end; and
slicing said frame that is transmitted upstream using the digital subscriber line head-end.

15. The digital subscriber line communication method of claim 14, further comprising slicing the frame that is transmitted upstream using time-division multiple access processing.

16. The digital subscriber line communication method of claim 15, further comprising slicing the frame that is transmitted upstream using code division multiple access processing.

17. The digital subscriber line communication method of claim 14, wherein the data that are broadcast downstream comprise an IEEE compatible 802.3 frame.

18. The digital subscriber line communication method of claim 14, wherein the data that are broadcast upstream from the user comprise a fragmented IEEE compatible 802.3 frame.

19. A digital subscriber line communication method, comprising:
broadcasting data downstream from a digital subscriber line head-end;
extracting a payload portion of said broadcast data;
forwarding the payload portion of said data to at least one user within a plurality of users;
assembling a frame from data provided by at least one user;
transmitting the frame upstream to a receiver using point-to-point protocol.
